(19) United States
(12) Patent Application Publication
(10) Pub. No.: US 2014/0310859 A1
(43) Pub. Date: Oct. 23, 2014

(54) Bedside Urinal Appliance

(71) Applicant: Henry Brown, Swaffham Prior (GB)

(72) Inventor: Henry Brown, Swaffham Prior (GB)

(21) Appl. No.: 14/124,949

(22) PCT Filed: Jun. 27, 2012
(86) PCT No.: PCT/GB2012/051498

§ 371 Date: Mar. 7, 2014

(30) Foreign Application Priority Data
Jun. 27, 2011 (GB) 1110935.2
Dec. 30, 2011 (GB) 1122510.9

(51) Int. Cl. A61G 9/00; A47K 11/12

(52) U.S. Cl. CPC A61G 9/006; A47K 11/12
USPC 4/144.1

(57) ABSTRACT

A portable urinal appliance is provided comprising a funnel (7) for receiving urine; a flexible hose (8) connected to the funnel; a container (6) connected to the flexible hose for receiving and storing urine input at the funnel; wherein the appliance further includes a funnel support (10), located with respect to the container so that when the appliance is not in use the funnel is held upright and higher than the level of urine in the container.

### BACKGROUND TO THE INVENTION

1. Field of the Invention

This invention relates to bedside toilet appliances and in particular a portable bedside urinal.

2. Related Art

For some individuals, such as those with mobility problems, recovering from injuries or surgery, or suffering from incontinence, it is desirable to be able to urinate in a hygienic manner without the need to move to the bathroom. In these instances a bedside urinal may be used, e.g. a chamber pot.

Alternatively, a bed bottle may be used. This has the advantage over a chamber pot that the user need not leave their bed to urinate. A known bed bottle has the general form of a bottle, with a neck portion extending generally upwardly from a body of the bottle. The body has a flat bottom portion for resting the bottle in a vertical orientation. The body also has a flat side portion in order to allow the bottle to be rested general horizontally.

When the bottle is oriented horizontally, resting on its flat side portion, the neck portion does not extend strictly horizontally. Instead, with the bottle in this orientation the neck portion extends slightly upwardly from horizontal. The effect of this is that the opening of the neck is higher than the body of the bottle. This allows the user to urinate into the bottle with the bottle held horizontally, the urine then being held in the body portion of the bottle.

There are several problems with such a bed bottle. The bed bottle is typically placed on the floor or on a night stand between uses. When the bottle is placed on the floor, the user (being in bed) must reach down to the floor in order to pick up the bed bottle before it can be used. This may be difficult for some users, such as those with limited mobility. Whether on the floor or on a night stand, the bed bottle suffers from a lack of stability. This problem arises when the bed bottle is placed in the vertical position because the surface area of the bottom portion is relatively small. This problem is exacerbated as the bottle becomes increasingly filled with liquid because the centre of gravity of the bed bottle is raised away from the bottom portion. As will be understood, further problems arise if the user elects to place the bottle on its flat side portion between uses, since subsequent movement of the bottle is likely to result in spillage of urine from the bottle, because the angle of the neck portion is shallow.

In some situations, the bed bottle can be difficult to find, for example in a darkened room, if the user has poor eyesight or is temporarily disorientated. This is a particular problem if a bed bottle is used on multiple occasions without emptying between uses. Unless the user is careful to return the bottle back to the same position, the user may have to feel around in the dark for the bottle and inadvertently tip it over, especially where the bottle is placed vertically.

A further problem with the bed bottle is that it can only hold a limited amount of urine, meaning that multiple bottles may be needed for some users, when repeated emptying would be impractical, such as during the night. In addition, after a first quantity of urine has been added to the bottle, there is a risk that this may be spilled when the bottle is lifted and moved to the horizontal position for subsequent use.

U.S. Pat. No. 2,522,273 discloses a bedside urinal which is designed to be fixed to a mattress. The bedside urinal has a funnel for receiving urine and a rigid tube for receiving urine input from the funnel. Upper and lower clamp plates are attached to the rigid tube and clamp on to a mattress to fix the urinal in position. The funnel of the urinal shown in U.S. Pat. No. 2,522,273 is fixed in position and cannot be moved by a user into a convenient position for use. This arrangement means that a user must move towards the ends of the bed and position themselves against the funnel, rather moving the funnel towards them, which can be inconvenient, particularly at night. This urinal is not easily portable.

WO 2004/087035 discloses a bedside urine collection device which is of relatively complex structure, apparently intended mainly for use in hospitals. A urine collection receptacle, appropriately shaped for the gender of the patient, is releasably connected to flexible tubing which leads to a reservoir such as a catheter bag. A check valve is located in the tubing adjacent the urine collection receptacle, in order to prevent urine from flowing backwards along the tubing and back out of the urine collection receptacle.

An electrically operated peristaltic pump acts on the exterior of the tubing in order to pump urine along the tubing to the reservoir. In order for the peristaltic pump to provide a useful effect, the tubing must therefore have high flexibility.

### SUMMARY OF THE INVENTION

The present inventor has realised that the bedside appliances proposed in the prior art have drawbacks particularly with regard to ease of use and avoidance of spillage during night-time hours. Accordingly, the present invention provides a urinal which is portable and convenient to use without the need for a user to leave the bed, but which is of simple construction, of particular utility in the home.

The present invention provides a portable bedside urinal which comprises:
a funnel for receiving urine;
a hose connected to the funnel;
a container connected to the hose for receiving and storing urine input at the funnel;
a funnel support, located with respect to the container so that when the appliance is not in use the funnel is held upright and higher than the level of urine in the container, the funnel support being shaped to circumscribe the funnel and hose so that, when the appliance is in use, the hose is guided through the funnel support and unable to escape from the funnel support,
   wherein the hose has a bending stiffness, defined as the force required to deform the unstressed straight hose to a U-shape with a minimum inner bending radius of 20 cm, of at least 1N and not more than 10N, and the hose has a length from funnel support to funnel, when extended in use, of 200 cm or less, to allow the hose to guide the funnel back into the funnel support after use.

The bending stiffness of the hose is measured according to ISO 1746: 2000, the content of which is hereby incorporated by reference in its entirety. ISO 1746: 2000 (“Rubber or plastics hoses and tubing—Bending tests”) sets out a measurement test in Method A of that document, in which two parallel guides are moveable towards each other under the influence of a force applied by a suitable weight and pulley system. A suitable length of hose is placed between the guides, the force between the guides bending the hose into a U-shape. Taking the outer diameter of the hose as D, the separation of the guides is (C+2D), where C is twice the minimum inner bending radius of the hose (i.e. the minimum bending diameter of the hose).

By “minimum inner bending radius”, it is intended to refer to the minimum value of bending radius measurable around the U-shape of the bent hose. It will be understood that in the ideal scenario, the hose is bent uniformly to form a semicircular shape, so that the bending radius is constant around the curve of the U-shape. However, in the more general scenario, the bending radius typically varies around the curve of the U-shape, and so we refer to the radius of curvature at the minimum inner bending radius.

As will be understood, the bending stiffness of the hose is thus relatively high, although not so high that the user cannot direct the funnel to the required location. The high bending stiffness means that the hose is less likely to buckle when the user is replacing the funnel after use. Thus, the funnel can be very easily replaced in the support because it is guided into the support by the non-buckling hose. In the context of the present invention, the hose is thus described as “semi-rigid”.

Optional features of the invention will now be set out. These may be combined, either singly or in any combination with any aspect of the invention.

Preferably, the bending stiffness of the hose is 2N or more.

The hose preferably has an inner diameter of about 10 mm, or greater. This allows the hose to have an adequate flow capacity. The hose outer diameter is preferably not more than 20 mm (about 16 mm preferred). This allows uniformity of interaction between the hose and the funnel support. Hoses of larger outer diameter may be unwieldy in this application. Typical hose wall thickness of at least 2 mm is acceptable. The hose preferably has a wall thickness not greater than 6 mm.

The hose preferably has a mass per unit length of at least 100 gm⁻¹. More preferably, the mass per unit length of the hose is at least 150 gm⁻¹. Higher mass per unit length (e.g. 200 gm⁻¹ or greater, or 400 gm⁻¹ or greater, is acceptable. This relatively heavy hose has the advantage that the funnel is more securely guided back into the funnel support by the weight of the hose below the funnel support. In this way, after use of the funnel, the user need only locate the funnel in the vicinity of the funnel support and let go of the funnel.

The weight of the hose below the funnel support can then ensure that the funnel is received securely in the funnel support.

Preferably, the length of the hose when extended is at least 50 cm.

The semi-rigid nature of the hose ensures that the hose resists kinking and buckling within the typical operating forces to which the hose is subjected. This ensures easy draining of urine from the funnel to the container without any requirement for a pump. As will be apparent, the use of a semi-rigid hose would in any event mean that the use of a peristaltic pump (for example) would be very difficult.

In a preferred embodiment, the semi-rigid hose is made from braided PVC tubing. Alternatively, any suitable waterproof tubing may be used as the hose with a spring coil jacket wrapped around the material to form a composite hose. For example, domestic shower hose can be used. The spring coil increases the bending stiffness to allow the composite hose to have the required performance. Alternatively, a suitable pressure hose may be used.

The provision of a funnel support allows the funnel to be held in an upright position and higher than the level of urine in the container. When the funnel is held in this position stored urine is not able to leak back out of the funnel.

The funnel holder also ensures that the funnel is held in an upright position which is a convenient position to be picked up by the user. In addition, by providing a funnel holder for storing the funnel when the appliance is not in use, the funnel will always be returned to, and held in, the same position, meaning a user can be sure of the location of the funnel, even in poor light conditions.

In some embodiments, the funnel support is height-adjustable with respect to the container.

The provision of a height-adjustable funnel support means that the height of the funnel support can be altered with respect to the container to suit the needs of the user. In turn, the funnel, which is held by the funnel support when the appliance is not in use, is held at a convenient height for the needs of the user. For example, when a user is in bed, the funnel support can be used to position the funnel at approximately the same height as the mattress. Alternatively, if a user is sat in a chair, then the funnel support can be adjusted to position the funnel at approximately the height of the arm of the chair. This means that when the appliance is not in use, and the funnel is placed in the funnel support, then the funnel is held at a convenient height within reach of the user.

In a preferred embodiment the inner diameter of the funnel support is substantially equal to the outer cross sectional diameter of a portion of the funnel, so that when the appliance is not in use the funnel is held in place by engagement of the funnel support with the portion of the funnel that is approximately equal in diameter to the funnel support.

The provision of a funnel support having an inner diameter substantially equal to the outer cross sectional diameter of a portion of the funnel allows the funnel support to contact and engage with the portion of the funnel. This means that the funnel will not be able to pass completely through the funnel support. When the appliance is not in use and the funnel has been returned to the funnel support, the funnel will be held in place by contact between the portion of the funnel which is approximately equal in diameter to the funnel support, and the funnel support.

Preferably, the funnel support provides a smooth surface for guiding the hose and contacting the funnel. This surface may have a curved profile. This allows the hose to be guided through the funnel support smoothly, reducing friction and the risk of snagging.

Preferably the funnel is adapted to the shape of the male anatomy. The funnel is preferably at least 15 cm long. At its open end, the funnel preferably has an internal diameter of at least 4 cm. The internal diameter at the open end is preferably not more than 6 cm. The internal diameter of the funnel preferably reduces substantially continuously via a taper from the open end to the end connected to the hose. Preferably the maximum angle of the taper, defined with respect to the principal axis of the funnel, is 15°. More preferably, the maximum angle of this taper is 10°. This shallow taper helps to ensure that no urine becomes trapped in the funnel, to be spilled out of the funnel later.

Preferably the end of the funnel connected to the hose has an internal diameter substantially the same as the internal diameter of the hose. Again, this helps to ensure that no urine becomes trapped at the interface between the hose and the funnel.

With regards to the external profile of the funnel, preferably the external shape of the funnel substantially follows the internal shape of the funnel. A substantially continuous reduction in the outer diameter of the funnel helps to ensure that the funnel is smoothly guided into the funnel support.

Preferably, the end of the funnel connected to the hose has a portion with an outer diameter substantially equal to the outer diameter of the hose. This allows the outer profile of the funnel to meet the outer profile of the hose. In this way, discontinuities in the outer shape of the funnel and hose can be avoided, and so help to ensure that the hose and funnel are smoothly guided into the funnel support.

Preferably, the maximum internal width of the funnel support is more than 60%, but less than 95% of the maximum external width of the funnel. This allows the funnel support to support the funnel near the open end of the funnel, helping the funnel to be held upright in the funnel support.

In a preferred embodiment, the appliance includes a base portion having a width (e.g. diameter) wider than the width (e.g. diameter) of the base of the container, and preferably wider than the cross sectional diameter of the top of the container. This lends additional stability to the apparatus.

In some embodiments, the container includes a handle for lifting and transporting the appliance. It is desirable for the urinal to be portable, so that it can easily be transported for cleaning, or moved by a user or carer to a position which is most convenient for use.

In some embodiments, the container includes a spout, to allow urine to be poured from the container. In a preferred embodiment the spout is positioned opposite the handle so that liquid can be poured from the container easily.

In some embodiments, the container includes a lid, the hose connecting to the container at a position below the level of the lid. The lid assists in containing odour escaping from the apparatus.

It is preferred that the funnel support and the position at which the hose connects to the container are circumferentially disposed from each other. This allows the hose to loop at least partially around the container. This is advantageous because it helps to guide the hose back though the funnel support after use.

In some circumstances, the hose may define a downward slope all the way from the funnel to the container when in use. However, in normal use, this is typically not the case. Due to a preference to avoid tension in the hose, the hose, part of which may rest on the floor, may be only partially tensioned and may retain a sag and an amount of urine. Due to this, the procedure when emptying the container is preferably first to lift the funnel upwards to allow the hose to define a downwards slope all the way from the funnel to the container, so that any residual urine in the hose is discharged into the container.

### BRIEF DESCRIPTION OF THE DRAWINGS

A preferred embodiment of the invention will now be described, by way of example only, with reference to the accompanying drawings, in which:

FIG. 1 shows a schematic view of a urinal appliance in a before-use and after-use configuration according to a preferred embodiment of the present invention.

FIG. 2 shows the urinal appliance according to FIG. 1 in a use configuration.

FIG. 3 shows a schematic cross sectional view of a funnel for use in the appliance of FIG. 1.

FIG. 4 shows a schematic view of a test procedure to determine hose bending stiffness (from ISO 1746: 2000).

FIGS. 5-8 show further, more detailed, schematic views of the test procedure to determine hose bending stiffness (from ISO 1746: 2000).

### DETAILED DESCRIPTION OF PREFERRED EMBODIMENTS AND FURTHER OPTIONAL FEATURES OF THE INVENTION

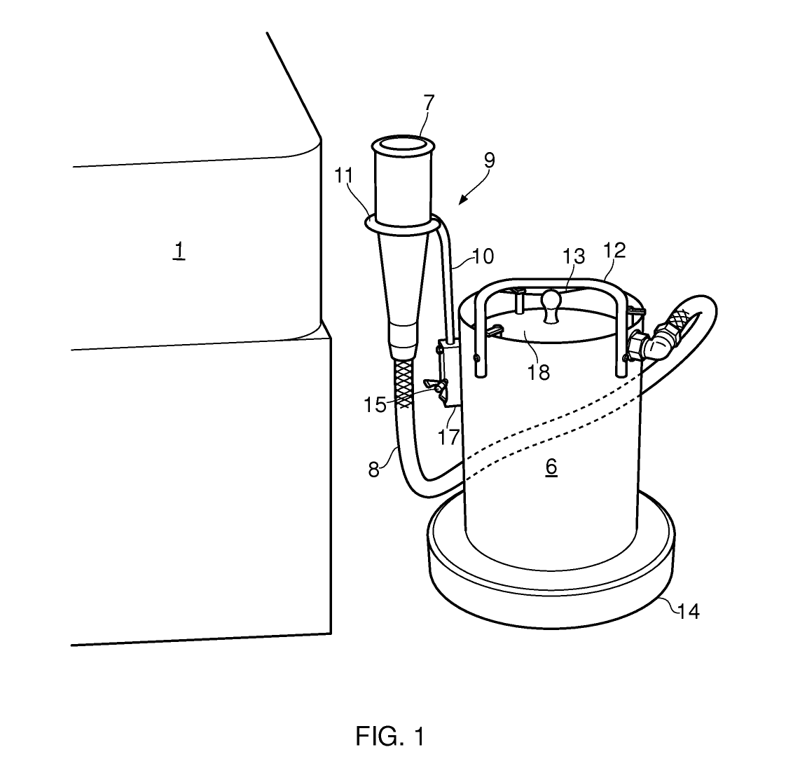

Referring to FIG. 1, the bedside urinal appliance is shown with reference to a bed 1, to illustrate the intended position and configuration of the appliance. The appliance includes a funnel for receiving urine 7, a semi-rigid hose connected to the funnel 8 and a container 6 connected to the flexible hose for receiving and storing urine. An internal spout (not shown) is provided to direct urine from the hose down into the container. In some embodiments the internal spout is absent and urine enters the container directly from the hose. A funnel support 9 is connected to the container for holding the funnel when the appliance is not in use.

The funnel support 9 comprises a stem portion 10 and a funnel-holding portion 11. When the appliance is not in use the funnel-holding portion 11 engages with the funnel 7 to hold the funnel upright in a position determined by the position of the funnel support.

The diameter of the funnel-holding portion is sized so that it engages with the funnel closer to the open end of the funnel than to the hose. This allows the funnel to be securely held in the upright position shown in FIG. 1.

The funnel-holding portion 11 if formed in this embodiment by bending a circular cross section aluminium rod to circumscribe the funnel. The smooth curved shape of the aluminium rod ensures that the hose glides easily through the funnel-holding portion.

Stem portion 10 is connected to the side of the container 6 via stem portion guide 17. Stem portion 10 extends into an axial bore in stem portion guide 17 and is axially slidable within that bore in order to adjust the height of the funnel-holding portion. An adjustment screw 15 is provided in order to fix the position of the stem portion 10 with respect to the stem portion guide 17.

It will be apparent that the height of the funnel support can be adjusted via various equivalent means, e.g. via a resistance fit or via telescopic extension means.

A handle 12 is located near the rim of the container. Opposite the handle 12 a spout 13 is provided in the rim of the container to allow urine to be poured from the container.

The handle and the spout may be arranged at any points along the circumference of the container. Although in the shown embodiment the handle 12 is located opposite the spout 13, in other embodiments the handle may be located adjacent to the spout or in any other position relative to one another.

In the embodiment shown, the position of the handle 12 is fixed with respect to the container. However, the handle may also be moveable with respect to the container. For example the handle may be attached at a pair of pivots which allow the handle to be raised and lowered for convenient storage.

As shown in FIG. 1, the height of the funnel support is adjusted in order for it to present the funnel to the user at a convenient height relative to bed 1.

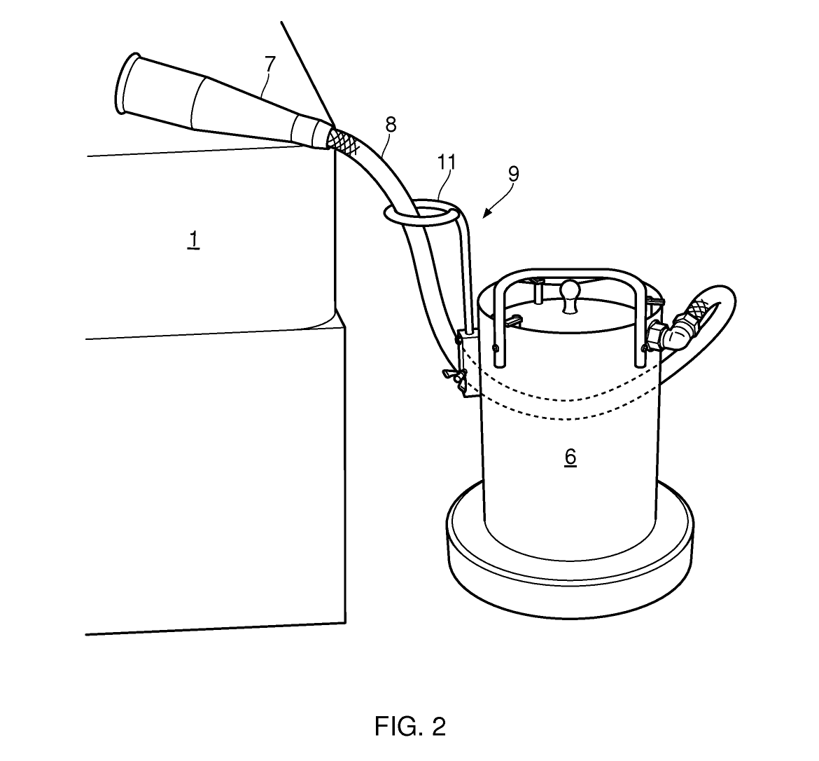

FIG. 2 shows the appliance in a use configuration, in which the funnel 7 is lifted away from the funnel support 9. The hose 8 is guided by the funnel-holding portion 11, which substantially encircles the hose to prevent the hose from being removed laterally from the funnel-holding portion 11. In the configuration shown in FIG. 2, the funnel is removed by the user from the funnel support and extended to the bed. This is accommodated by the length of the hose. As seen in FIG. 2, if the funnel is extended further, the hose slopes generally downwards from the funnel to the position at which the hose connects to the container. After use, the user must replace the funnel in the funnel support. This is easily achieved because the weight of the hose assists in guiding the funnel into the funnel support. Furthermore, the stiffness of the hose means that as the user receives tactile feedback as to the location of the funnel support. The stiffness of the hose prevents the hose from buckling or kinking. The result of the suitable stiffness of the hose, and the guidance of the hose through the funnel support, is that, in use, the motion of the funnel is guided by the wrapping and unwrapping of the hose around the container.

Foot 14 is attached to the base of the container to increase stability. The diameter of the foot is greater than the diameter of the base of the container and indeed of any part of the container. The purpose of the foot is to increase stability of the container and therefore the foot may also be relatively massive (heavy) compared to the filled weight of the container, to ensure that as the container is filled, the centre of gravity of the appliance remains low with respect to the height of the container. In some embodiments the foot may be integral with the container.

The hose may be made of any suitable waterproof material and to any appropriate length. A suitable length for the hose is between 2 m and 0.5 m in length, depending on the height of the bed and the distance of the user from the container. The hose may be connected to the container by any suitable connector providing a watertight seal. Similarly, the hose may be connected to the funnel by any suitable connector providing a watertight seal. Alternatively, in some embodiments the funnel may be integral with the hose.

In the preferred embodiment, the hose is semi-rigid and is formed from braided PVC tubing with an inner diameter of 10 mm and an outer diameter of 16 mm. Such tubing has a bending stiffness of about 2-10N according to the measurement procedure explained below. A particularly preferred hose is PVC hose reinforced with 1000 denier polyester yarn, with inner diameter 10 mm and outer diameter 16 mm (part number RP10/16 available from Colex International Limited of Unit G1, Valley Way, Welland Business Park, Market Harborough, Leicestershire, LE16 7PS, UK), having a bending stiffness of about 2.5N.

The container may be made from any suitable waterproof material (e.g. plastic material or corrosion-resistant metal) that may be sterilized and maintained in a proper sanitary condition. In a preferred embodiment the container is made of a hardened plastic material.

Lid 18 is provided in order to cover the contents of the container. This reduces odour from the appliance. Preferably the lid is removable for cleaning and sterilization of the appliance.

The hose may be disconnected from the funnel and the container for sterilization.

It is envisaged that the urinal appliance of the present invention will find use in nursing homes and hospitals, as well as for personal use in the home.

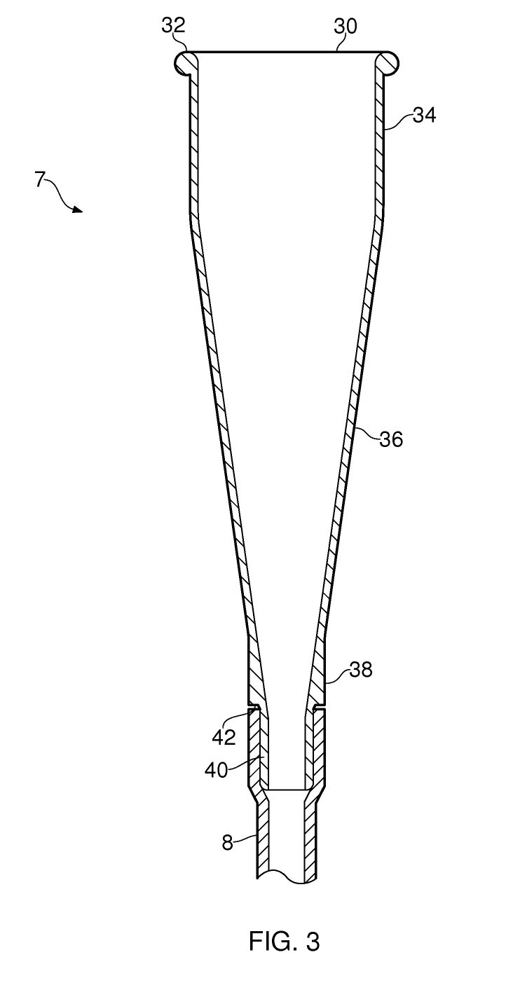

With reference to FIG. 3, there is shown a cross sectional view of the funnel 7. The open end 30 of the funnel is formed with a thickened bead 32 in order to enhance user comfort. The internal profile of the funnel substantially matches the external profile. A short cylindrical section 34 close to the open end communicates with a tapered portion 36 which tapers at an angle of about 7.5° to a hose connection portion 38. At the hose connection portion, the internal diameter matches the internal diameter of the hose 8. The internal shape and dimensions of the funnel allow the funnel to used comfortably by a man, the shallow taper ensuring that urine should not flow back to the user during use.

At the hose connection portion, there is formed a narrow cylindrical external protrusion 40 which mates via a frictional fit (or other suitable engagement) with the hose 8. Step 42 is formed between the body of the funnel and the narrow cylindrical external protrusion of a height in order to provide a gentle outer profile transition from the hose to the funnel. This helps to avoid snagging of the funnel during replacement in the funnel support.

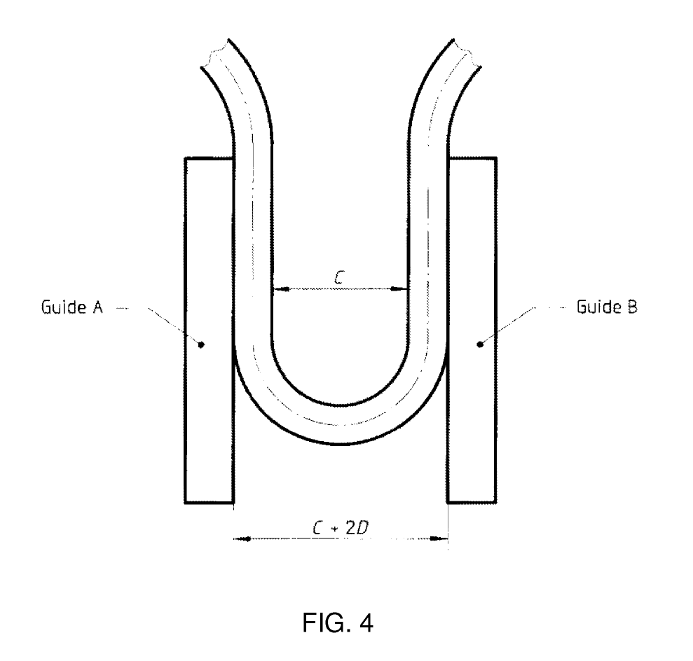

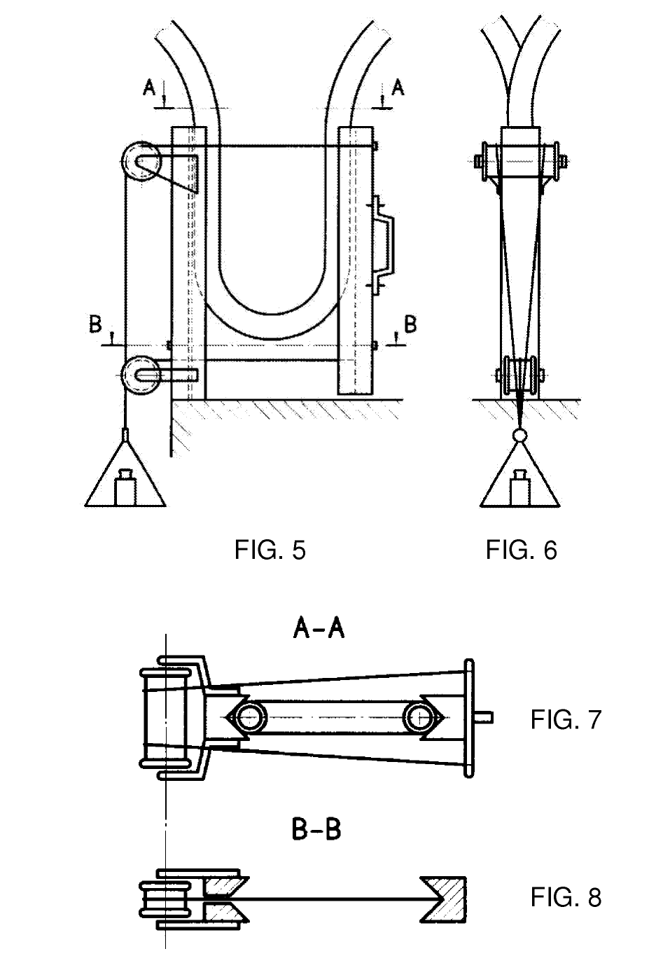

The bending stiffness of the hose is measured according to ISO 1746: 2000, the content of which is hereby incorporated by reference in its entirety. The measurement takes place at room temperature. ISO 1746: 2000 (“Rubber or plastics hoses and tubing—Bending tests”) sets out a measurement test in Method A of that document, in which two parallel guides, illustrated as Guide A and Guide B in FIG. 4 are moveable towards each other under the influence of a force applied by a suitable weight and pulley system (illustrated in FIGS. 5-8). The guides are treated in order to minimise friction with the hose. A suitable length of straight hose (straight in its unstressed state) is placed between the guides, and the guides are brought together to bend the hose into a U-shape. Taking the outer diameter of the hose as D, the separation of the guides is (C+2D), where C is twice the minimum inner bending radius of the hose (i.e. the minimum bending diameter of the hose). The force acting on the hose is the force due to the weight acting on the pulley system. FIG. 6 shows the measurement apparatus of FIG. 5 from the side. FIGS. 7 and 8 show sections views along A-A and B-B in FIG. 5, respectively.

The present invention has been described with reference to preferred embodiments. Modifications of these embodiments, further embodiments and modifications thereof will be apparent to the skilled person on reading this disclosure and as such are within the scope of the invention.

1. A portable bedside urinal comprising:
a funnel for receiving urine;
a hose connected to the funnel;
a container connected to the hose for receiving and storing urine input at the funnel;
a funnel support, located with respect to the container so that when the appliance is not in use the funnel is held upright and higher than the level of urine in the container, the funnel support being shaped substantially to circumscribe the funnel and hose so that, when the appliance is in use, the hose is guided through the funnel support and unable to escape from the funnel support,
wherein the hose has a bending stiffness, defined as the force required to deform the unstressed straight hose to a U-shape with a minimum inner bending radius of 20 cm, of at least 1N and not more than 10N, and the hose has a length from funnel support to funnel, when extended in use, of 200 cm or less, to allow the hose to guide the funnel back into the funnel support after use.

2. The portable bedside urinal according to claim 1 wherein the bending stiffness of the hose is 2N or more.

3. The portable bedside urinal according to claim 1 wherein the hose has a mass per unit length of at least 100 gm⁻¹.

4. The portable bedside urinal according to claim 1 wherein the funnel support is height-adjustable with respect to the container.

5. The portable bedside urinal according to claim 1 wherein the inner diameter of the funnel support is substantially equal to the outer cross sectional diameter of a portion of the funnel, so that when the appliance is not in use the funnel is held in place by engagement of the funnel support with the portion of the funnel that is approximately equal in diameter to inner diameter of the funnel support.

6. The bedside urinal according to claim 1 wherein the funnel support provides a smooth surface for guiding the hose and contacting the funnel.

7. The portable bedside urinal according to claim 1 wherein the end of the funnel connected to the hose has an internal diameter substantially the same as the internal diameter of the hose.

8. The portable bedside urinal according to claim 1 wherein the end of the funnel connected to the hose has a portion with an outer diameter substantially equal to the outer diameter of the hose, allowing the outer profile of the funnel to meet the outer profile of the hose substantially without discontinuities.

9. The portable bedside urinal according to claim 1 wherein the funnel support and the position at which the hose connects to the container are circumferentially disposed from each other, allowing the hose to loop at least partially around the container.

10. The bedside urinal according to claim 1 wherein, in use, the motion of the funnel is guided by the wrapping and unwrapping of the hose around the container.
